(19) United States
(12) Patent Application Publication
(10) Pub. No.: US 2026/0291869 A1
(43) Pub. Date: Sep. 24, 2026

(54) SELECTING FLOWS TO REROUTE BASED ON BYTES REMAINING AS AN INDICATOR

(71) Applicant: Hewlett Packard Enterprise Development LP, Spring, TX (US)

(72) Inventors: Abdulla M. Bataineh, Vista, CA (US); Duncan Roweth, Bristol (GB)

(21) Appl. No.: 19/084,450

(22) Filed: Mar. 19, 2025

(51) Int. Cl. H04L 47/122; H04L 47/24; H04L 47/283

(52) U.S. Cl. CPC H04L 47/122; H04L 47/24; H04L 47/283

(57) ABSTRACT

A system receives, by an ingress port in a network fabric, a first packet of a flow. The system stores, in a data structure, a number of bytes remaining in the flow to be transmitted. The system updates the number of bytes remaining in the flow in response to receiving from a source of the flow additional messages of the flow and from a destination of the flow acknowledgments (ACKs) corresponding to previously transmitted packets of the flow. The system identifies, based on mid-fabric congestion detected by intermediate ports in the network fabric, a plurality of candidate flows to be rerouted. The system selects a first flow from the candidate flows based on a respective number of bytes remaining in the flow, the first flow associated with a first path. The system reroutes the first flow from the first path to a new path.

### BACKGROUND

In a network fabric, paths may be selected for ordered flows based on load. Persistent flows may result in a load imbalance over time, and some paths may be more heavily used than others. Congestion may be detected by a mid-fabric fabric port. Relaying this “mid-fabric congestion” to the ingress port can allow the ingress port to select, from a plurality of candidate flows, a flow to reroute on a different path. However, rerouting flows may affect the cost and efficiency of the network fabric. Techniques for selecting the best flow to reroute may be valuable.

### BRIEF DESCRIPTION OF THE FIGURES

FIG. 1 illustrates an environment which facilitates selecting flows to reroute based on bytes remaining as an indicator, in accordance with an aspect of the present application.

FIG. 2 illustrates an environment which facilitates selecting flows to reroute based on bytes remaining as an indicator, in accordance with an aspect of the present application.

FIG. 3A illustrates a direct method (extension header) which facilitates selecting flows to reroute based on bytes remaining as an indicator, in accordance with an aspect of the present application.

FIG. 3B illustrates a direct method (options field) which facilitates selecting flows to reroute based on bytes remaining as an indicator, in accordance with an aspect of the present application.

FIG. 4A presents a flowchart illustrating a method which facilitates selecting flows to reroute based on bytes remaining as an indicator, in accordance with an aspect of the present application.

FIG. 4B presents a flowchart illustrating a method which facilitates selecting flows to reroute based on bytes remaining as an indicator, in accordance with an aspect of the present application.

FIG. 5 illustrates a computer system which facilitates selecting flows to reroute based on bytes remaining as an indicator, in accordance with an aspect of the present application.

FIG. 6 illustrates a computer-readable medium which facilitates selecting flows to reroute based on bytes remaining as an indicator, in accordance with an aspect of the present application.

In the figures, like reference numerals refer to the same figure elements.

### DETAILED DESCRIPTION

Aspects of the present application provide a system which facilitates selecting flows to reroute based on bytes remaining as an indicator.

A network fabric may include ingress network devices, intermediate network devices, and egress network devices. Data may travel through the network fabric as a “flow,” i.e., a stream of messages/packets from one source to one destination (e.g., from one ingress network device to one egress network device). Paths through the network fabric for ordered flows may be selected based on load. A flow may follow the same selected path while data is pending in the network fabric. Some flows, such as persistent flows which continue for a long period of time, may result in a load imbalance over time, e.g., the load may change over time, while some paths may be more heavily used than others.

Congestion may occur in the middle of the network fabric (i.e., “mid-fabric congestion” or “mid-point congestion” detected by an intermediate or mid-fabric network device) or at an egress of the network fabric (i.e., “endpoint congestion” detected by an egress or endpoint network device) when a packet for a flow is received. Too many flows may be forwarded to the same link, which can result in excess packets which are waiting in a queue to be given their share of the bandwidth of the link. Rerouting a flow that encounters endpoint congestion and which has already reached the egress network device may not provide benefits. In contrast, rerouting a flow that encounters mid-fabric congestion may result in an improvement in the overall efficiency of the network fabric because the rerouted flow will likely be directed onto a different mid-fabric link with fewer flows and spare bandwidth to take more packets. Mid-fabric congestion can be detected by a mid-fabric network device when a packet for a flow is received, and the mid-fabric network device may relay information on the detected mid-fabric congestion to the ingress network device and allow the ingress network device to reroute the flow to a new path.

However, rerouting flows may affect the performance and/or efficiency of the network fabric. As a result, an optimal selection of which flow(s) to reroute may have a significant impact on performance.

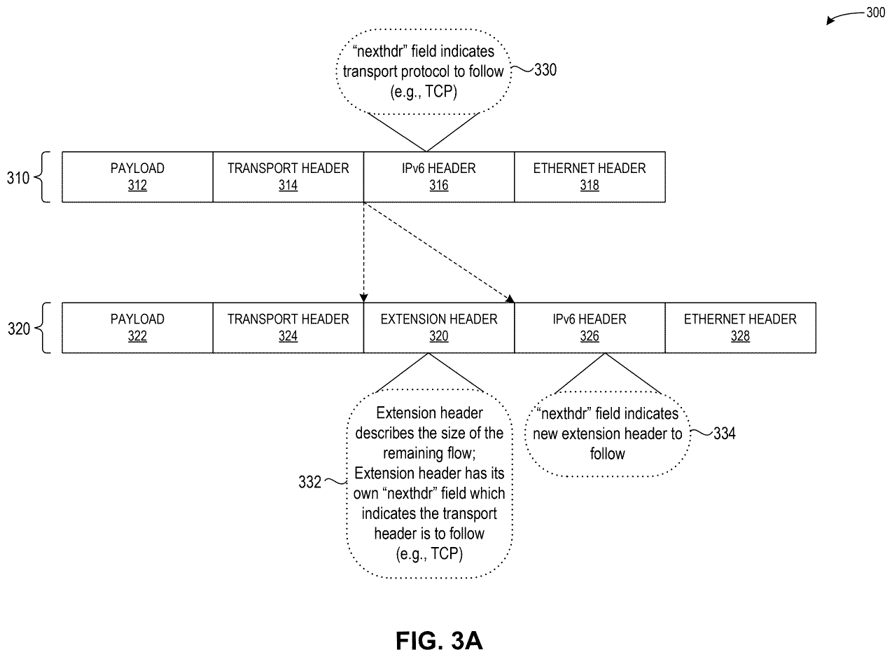

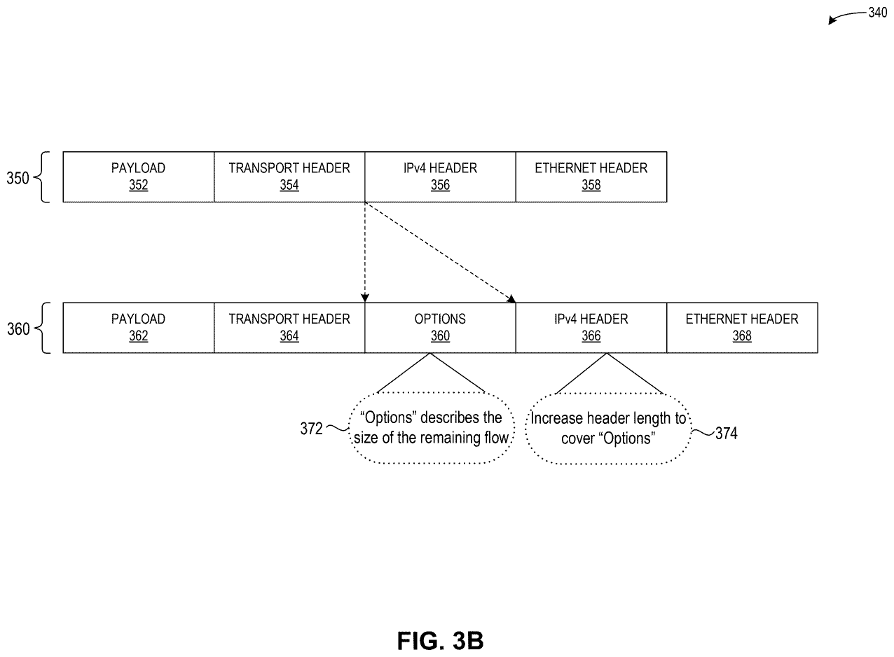

The described aspects provide a system which facilitates selecting a flow, from a plurality of candidate flows, to reroute based on the “bytes remaining in the flow to be transmitted” (referred to herein as “BR”). An ingress port may receive a flow and obtain information about the “extent” of the flow, i.e., a measure of how long the flow will continue to live. The extent of the flow can be expressed as the BR. Upon receiving the flow, the ingress port may obtain the BR directly (e.g., from a first packet of a message in the flow, a network interface controller or card (NIC) or software, from Internet Protocol (IP) options, or the transport layer headers) or indirectly (e.g., by inference from historical analysis of flows or by network management software which learns the behavior associated with similar traffic or flows). The ingress port may determine the BR based on information obtained from at least one of: the first packet of the flow; a header; an extension header; an IP option; a transport layer header; a software- or hardware-related component; or a NIC. Examples of obtaining or determining the BR are described below in relation to FIGS. 3A and 3B.

The ingress port can store the obtained or determined BR in a table or other data structure, increment the BR when receiving additional messages of the same flow (e.g., from the source of the flow), and decrement the BR when receiving ACKs from the flow destination egress port corresponding to previously transmitted packets of the same flow. For example, the ingress port may store the BR in a per-port data structure.

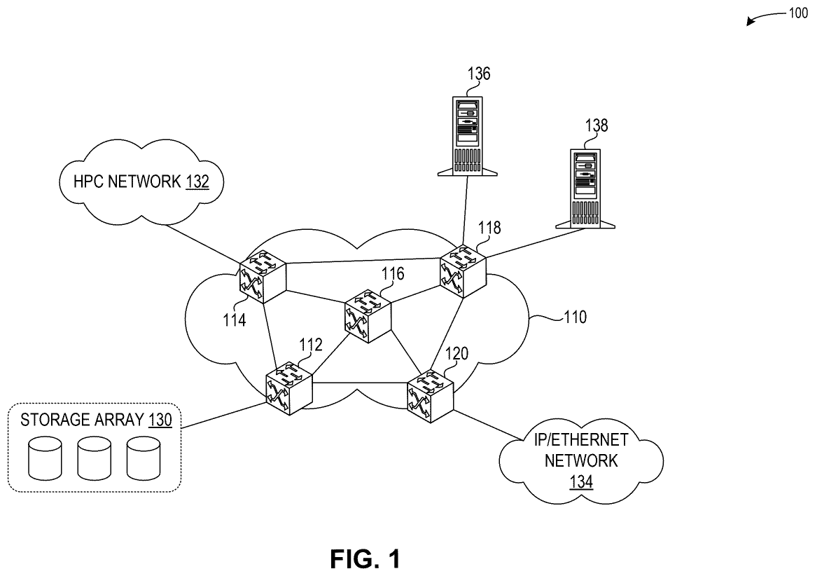

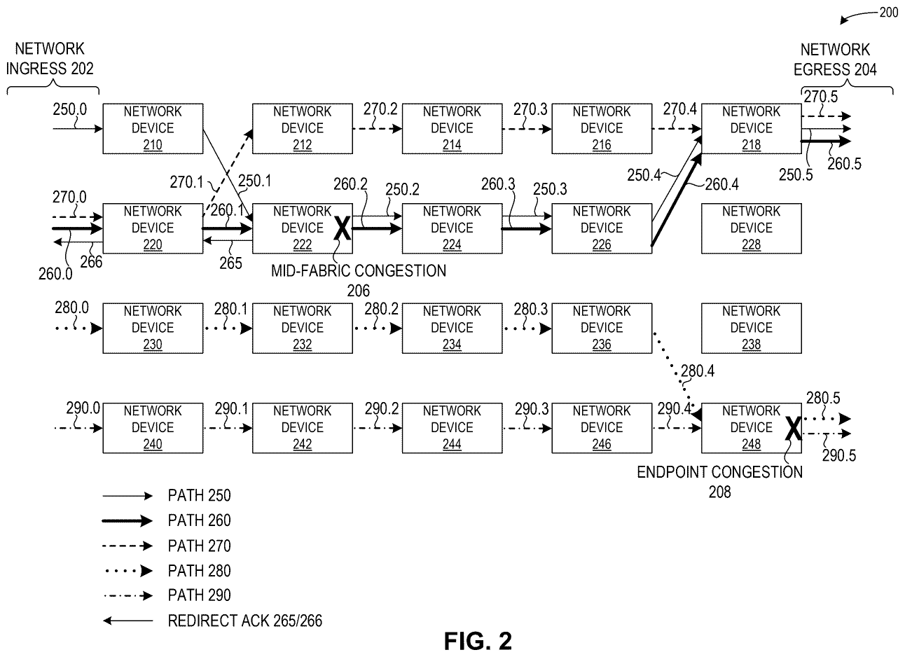

One or more mid-fabric switches may detect mid-fabric congestion by measuring load metrics on their ports, e.g., by detecting that more data is arriving at the ingress ports of that switch than able to leave on a given port. The load metric may be based on, e.g.: bandwidth consumption associated with the detecting switch port or network device; an amount of data pending in an input buffer associated with the detecting switch or network device; and information associated with a state of a respective flow. Other metrics may also be used to detect the mid-fabric congestion. Based on the generated load metric for a respective flow, a mid-fabric port may identify candidate flows to be rerouted, e.g., as described below relation to FIGS. 1 and 2. The mid-fabric ports may identify the candidate flows to be rerouted by sending a special “redirect” acknowledgment (ACK) to the ingress port.

The ingress port may identify a plurality of candidate flows to be rerouted, e.g., based on the redirect ACKs generated by the mid-fabric ports. The ingress port can score or order the candidate flows based on the current BR for a respective flow and can select a flow for rerouting based on the score. For example, the ingress port may calculate the score based on a comparison of the BR to the bandwidth delay product (BDP), which is the bandwidth of the links multiplied by the congestion-free round-trip time. The score can also be based on a comparison of the BR to an upper threshold or a lower threshold, i.e., if greater than the upper threshold, select for reroute; if less than the lower threshold, do not select for reroute. The score can also be based on a quantization of the BR, e.g., categories of small, medium, large, very large, where each category comprises a range of BRs and may be associated with a reroute decision. The categories may be based on a comparison of the BR to one or more predetermined thresholds or ranges of ratios between the BR and the BDP.

FIG. 1 illustrates an environment which facilitates selecting flows to reroute based on bytes remaining as an indicator, in accordance with an aspect of the present application. Environment 100 can include a network 110 of switches which can be referred to as a “switch fabric” or a “network fabric” and can include switches 112, 114, 116, 118, and 120. Each switch can have a unique address or identifier within switch fabric 110. Various types of endpoints, processing nodes, devices, and networks can be coupled to a switch fabric. For example, a storage array 130 may be coupled to switch fabric 110 via switch 112; a high performance computing (HPC) network (e.g., InfiniBand, Slingshot, or any other high performance network) 132 may be coupled to switch fabric 110 via switch 114; a number of end hosts, such as hosts 136 and 138, may be coupled to switch fabric 110 via switch 118; and an IP/Ethernet network 134 may be coupled to switch fabric 110 via switch 120. HPC network 132 may include multiple networked computer and storage devices concurrently running programs to complete different complex and performance-intensive tasks. IP/Ethernet network 134 may include physical Ethernet cabling and an application layer protocol between network devices based on IP, including communication via Transport Communication Protocol (TCP)/IP and User Datagram Protocol (UDP) packets. Switch fabric 110 may itself be an Ethernet network or an HPC network.

In general, a switch can have edge ports and fabric ports. An edge port can couple to a device that is external to the fabric. A fabric port can couple to another switch within the fabric via a fabric link. Typically, traffic may be injected into switch fabric 110 via an ingress port of an edge switch and may leave switch fabric 110 via an egress port of another (or the same) edge switch. An ingress link can couple a NIC of an edge device (e.g., an HPC end host) to an ingress edge port of an edge switch. Switch fabric 110 can then transport the traffic to an egress edge switch, which in turn can deliver the traffic to a destination edge device via another NIC. A packet can be forwarded in switch fabric 110 based on its Layer-2 address (“fabric address”), which may be viewed as an equivalent to a media access control (MAC) address in Ethernet. The forwarding path for the packet may be determined based on adaptive forwarding, e.g., based on local programming of the switches in switch fabric 110 and information related to load, traffic, and congestion available to and associated with switch fabric 110.

In some aspects, switch fabric 110 or HPC network 132 may include network devices (i.e., switches) including ingress network devices, intermediate or mid-fabric network devices, and egress or endpoint network devices. A switch in switch fabric 110 may include systems which perform operations associated with an ingress network device, an intermediate network device, and an egress network device. For example, switch 118 may be an ingress network device for data originating from device 136 and destined for IP/Ethernet network 134 (with switch 120 as the egress network device for such data), and switch 118 may also be an egress network device for data originating from IP/Ethernet network 134 and destined for device 136 (with switch 120 as the ingress network device for such data). In addition, a switch in switch fabric 110 may also include systems which perform operations associated with mid-fabric network devices. For example, switch 118 may be an intermediate network device for data originating from IP/Ethernet 134 and destined for HPC network 132, e.g., via a possible path which includes switch 120 (acting as an ingress network device), switch 118 (acting as an intermediate network device), and switch 114 (acting as an egress network device). Thus, a single switch may include systems which perform functionality relating to an ingress network device, an intermediate network device, and an egress network device.

As another example, switch 120 (acting as ingress network device 120) may receive a plurality of flows of data traveling from IP/Ethernet network 134 (“source”) to HPC network 132 (“destination”). A flow may include a plurality of messages, and a message may include a plurality of packets. The plurality of flows of data may travel via, e.g., intermediate network device 116 to egress network device 114. Upon receiving a flow, ingress network device 120 can determine a first packet of the flow and store, in a data structure, information relating to that flow, including, where such information is available, the number of bytes remaining in the flow to be transmitted (BR). Ingress network device 120 may also receive additional messages of the flow. In response to receiving those additional messages, ingress network device 120 may increment the BR stored in the data structure. Ingress network device 120 may also receive ACKs corresponding to the previously transmitted packets of the flow. In response to receiving those corresponding ACKs, ingress network device 120 may decrement the BR stored in the data structure.

Based on these flows of data traveling from the source to the destination, intermediate network device 116 may receive the flows and determine whether mid-fabric congestion is detected by generating a load metric for each port used by the flow, as described above. Based on the load metric and other factors (e.g., comparisons to benchmark thresholds), intermediate network device 116 may determine mid-fabric congestion associated with a flow, and intermediate network device 116 may send, to ingress network device 120, a redirect ACK indicating that the flow is a candidate to be rerouted. In some aspects, the redirect ACK may include the generated load metric and other information useful for decision making at the ingress port.

Ingress network device 120 may identify candidate flows of the plurality of flows (e.g., based on receiving, from intermediate ports such as intermediate network devices 116 and 118, redirect ACKs indicating mid-fabric congestion). Ingress network device 120 can select, from the candidate flows corresponding to the received redirect ACKs (which indicate mid-fabric congestion), a first flow to be rerouted based on the respective number of bytes remaining in the flow to be transmitted (BR).

Ingress network device 120 may select the first flow to be rerouted based on the BR, e.g., by assigning a score or category to each candidate flow. In one aspect, ingress network device 120 can assign a score or category to a flow by calculating the bandwidth delay product (BDP), which can be a product of the bandwidth of the links and a round-trip time associated with a packet of a flow, and comparing the BR to the BDP. For example, in a network with a bandwidth of 100 gigabytes per second (GB/s) and a round-trip time of 2.5 microseconds, the BDP may be expressed as: 100 GB/s*2.5 microseconds=250 kilobytes (KB). If a flow has a small amount of data remaining relative to the BDP (e.g., if the BR is less than 250 KB), ingress network device 120 may mark the flow as a weak candidate for rerouting (e.g., assign a lower-priority score). If a flow has a moderate amount of data remining relative to the BDP (e.g., if the BR is between 250 KB and 2.5 megabytes (MB)), ingress network device 120 may mark the flow as a moderate candidate for rerouting (e.g., assign a medium-priority score). If a flow has a large amount of data remaining relative to the BDP (e.g., if the BR is greater than 2.5 MB), ingress network device 120 may mark the flow as a strong candidate for rerouting (e.g., assign a high-priority score). Any number of categories may be used to represent different ranges of the number of bytes remaining in the flow, the BR compared to the BDP and other associated thresholds, etc.

Ingress network device 120 may also select the first flow to be rerouted based on other factors, including but not limited to, e.g.: an amount of time that has passed since a most recently rerouted flow; a comparison of the load metric of the respective flow of the plurality of flows to load metrics of other flows in the plurality of flows; or a difference, if available, between load metrics included in redirect ACKs received corresponding to a same flow. In addition, the factors used by ingress network device 120 may be associated with a probability of a respective flow from the plurality of flows being selected to be rerouted. The probability may increase based on an increase in the load (e.g., an increasing explicit congestion avoidance (ECA) value returned in the redirect ACK) or an increase in the packet size. For example, the system may select the first flow to be rerouted by using a probabilistic model based on the ECA value.

Ingress network device 120 can reroute the first flow to a new path and can also store information associated with the rerouted first flow, e.g., the load metric associated with the first flow, one or more redirect ACKs associated with the first flow, and the number of bytes remaining in the flow to be transmitted. Ingress network device 120 may use the stored information to determine subsequent candidate flows to be rerouted.

FIG. 2 illustrates an environment which facilitates selecting flows to reroute based on bytes remaining as an indicator, in accordance with an aspect of the present application. Environment 200 can include: ingress network devices 210, 220, 230, and 240; intermediate or mid-fabric network devices 212, 214, 216, 222, 224, 226, 232, 234, 236, 242, 244, and 246; and egress network devices 218, 228, 238, and 248. Environment 200 can be similar to network fabric 110 of FIG. 1 in that multiple paths may exist for data traveling from an ingress network device through one or more intermediate network devices to an egress network device. Data may be traveling through environment 200 via a plurality of paths, e.g.: a path 250 (indicated by a solid line) from a network ingress 202 to network device 210 (via a communication 250.1) to network device 222 (via a communication 250.1) to network device 224 (via a communication 250.2) to network device 226 (via a communication 250.3) to network device 218 (via a communication 250.4) and finally out to a network egress 204 (via a communication 250.5); a path 280 (indicated by a dotted line) from network ingress 202 to network device 230 (via a communication 280.0) to network device 232 (via a communication 280.1) to network device 234 (via a communication 280.2) to network device 236 (via a communication 280.3) to network device 248 (via a communication 280.4) and finally out to network egress 204 (via a communication 280.5); and a path 290 (indicated by an alternating dotted and dashed line) from network ingress 202 to network device 240 (via a communication 290.0) to network device 242 (via a communication 290.1) to network device 244 (via a communication 290.2) to network device 246 (via a communication 290.3) to network device 248 (via a communication 290.4) and finally out to network egress 204 (via a communication 290.5).

In addition, data may travel via a path 260 (indicated by a heavy solid line) from network ingress 202 to network device 220 (via a communication 260.0) to network device 222 (via a communication 260.1) to network device 224 (via a communication 260.2) to network device 226 (via a communication 260.3) to network device 218 (via a communication 260.4) and finally out to network egress 204 (via a communication 260.5).

During operation, an intermediate network device may detect mid-fabric congestion and an egress network device may detect endpoint congestion when a packet for a flow is received. For example, when a packet for a flow on path 250 or 260 is received, network device 222 (operating as an intermediate network device) may detect a mid-fabric congestion 206 (indicated by a bold “X”) related to the flows originating from ingress network devices 210 and 220. When a packet for a flow on path 280 or 290 is received, network device 248 (operating as an egress network device) may detect an endpoint congestion 208 (indicated by a bold “X”) related to the flows originating from ingress network devices 230 and 240.

Because egress network device 248 detects the endpoint congestion (relating to the flows on paths 280 and 290 originating from, respectively, network devices 230 and 240) upon the flow already reaching the egress of the network, rerouting those flows will not help those flows achieve improved performance. In such cases, the system may instead slow down the flows which contribute to the congestion at the ingress of the network (e.g., at 202).

In contrast, because the flows originating from network devices 210 and 220 have reached mid-fabric network device 222 and have not yet reached the egress of the network, rerouting those flows may result in improved performance. Furthermore, because rerouting flows may affect cost and performance, optimizing the selection of candidate flows to reroute may result in a significant improvement in cost and performance. For example, network device 222 can detect mid-fabric congestion 206 based on the generated load metric. Upon detecting mid-fabric congestion 206, network device 222 can send a redirect ACK to ingress network device 220 (via a communication 265 to network device 220). In some aspects, network device 220 may be an intermediate network device, which can send the redirect ACK to another ingress network device in network ingress 202 (e.g., via a communication 266). Network device 220 (and depicted ingress network devices 210, 230, and 240) may thus perform functionality associated with both an intermediate network device and an endpoint network device (as described above in relation to switches 116 and 120 in FIG. 1).

Ingress network device 220 may receive the redirect ACK from intermediate network device 222 (via communication 265) indicating mid-fabric congestion 206 relating to the flow originating from network device 220 (on path 260). Ingress network device 220 may also receive other redirect ACKS from other intermediate network devices indicating mid-fabric congestion relating to other flows on other paths (not shown). Each redirect ACK may include the load metric for the corresponding flow. As a result of the received redirect ACKs, ingress network device 220 may identify a plurality of candidate flows and select, from the candidate flows corresponding to the received redirect ACKs (which indicate mid-fabric congestion), a first flow to be rerouted based on the respective number of bytes remaining in the flow to be transmitted (BR). Ingress network device 220 may select the first flow to be rerouted based on the BR, including assigning a score or category to each candidate flow, e.g., by comparing the BR to the BDP and other associated thresholds, as described above in relation to ingress network device 120 of FIG. 1.

For example, ingress network device 220 may select, as the first flow to be rerouted, the flow originating from ingress network device 220 (on “first path” 260). Ingress network device 220 can reroute this selected first flow from the first path 260 to a “new path” 270 (indicated by a dashed line) from network ingress 202 to network device 220 (via a communication 270.0) to network device 212 (via a communication 270.1) to network device 214 (via a communication 270.2) to network device 216 (via a communication 270.3) to network device 218 (via a communication 270.4) and finally out to network egress 204 (via a communication 270.5). Ingress network device 220 can also store information associated with the rerouted first flow, e.g., the load metric associated with the first flow, one or more redirect ACKs associated with the first flow, and the number of bytes remaining in the flow to be transmitted. Ingress network device 220 may use the stored information to determine subsequent candidate flows to be rerouted.

FIG. 3A illustrates a direct method, using an extension header, which facilitates selecting flows to reroute based on bytes remaining as an indicator, in accordance with an aspect of the present application. In FIG. 3A, a packet 310 of a flow may include: an Ethernet header 318; an IPv6 header 316 (in which a “nexthdr” field indicates that the transport protocol is to follow, e.g., Transport Control Protocol (TCP), as indicated by an element 330; a transport header 314; and a payload 312. The described aspects may use an extension header in IPv6 as depicted in FIG. 3A, in which a packet 320 of a flow may include: an Ethernet header 328; an IPv6 header 326 (in which a “nexthdr” field indicates that the new extension header is to follow, as indicated by an element 334); an extension header 320; a transport header 324; and a payload 322. In IPv6, extension header 320 may be used to describe the size of the remaining flow. The extension header 320 field may have its own “nexthdr” field which indicates that the transport header is to follow (e.g., TCP), as indicated by an element 332.

FIG. 3B illustrates a direct method, using an options field, which facilitates selecting flows to reroute based on bytes remaining as an indicator, in accordance with an aspect of the present application. In FIG. 3B, a packet 350 of a flow may include: an Ethernet header 358; an IPv4 header 356; a transport header 354; and a payload 352. The described aspects may use the options field in IPv64 as depicted in FIG. 3B, in which a packet 360 of a flow may include: an Ethernet header 368; an IPv4 header 366 (in which the header length may be increased in order to cover the “options field” which is to follow, as indicated by an element 374); an options field 360; a transport header 364; and a payload 362. In IPv4, options field 360 may be used to describe the size of the remaining flow, as indicated by an element 372.

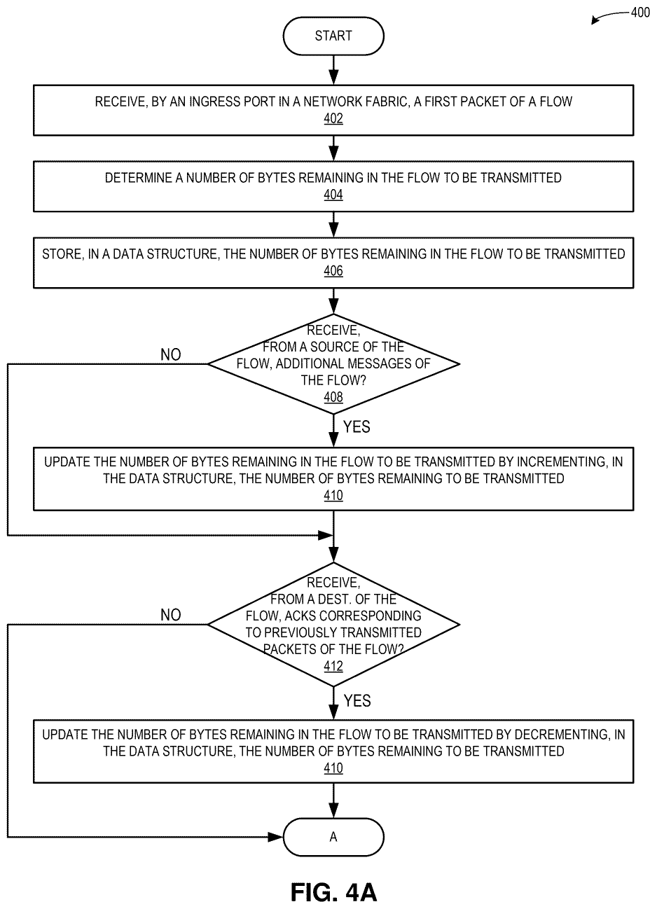

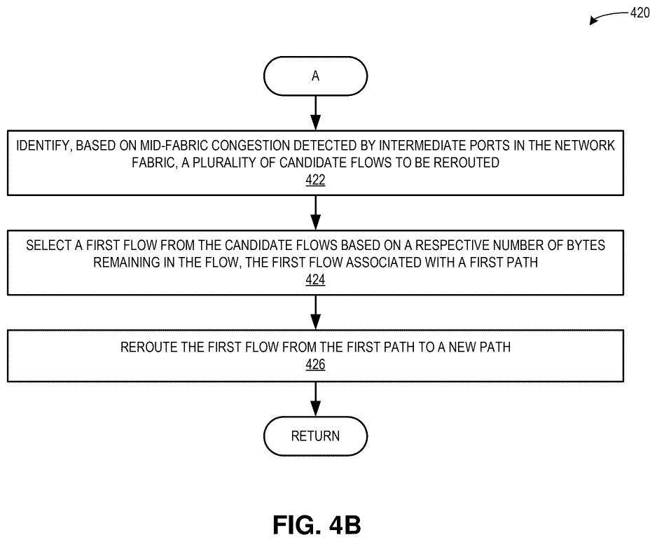

FIG. 4A presents a flowchart 400 illustrating a method which facilitates selecting flows to reroute based on bytes remaining as an indicator, in accordance with an aspect of the present application. During operation, the system receives, by an ingress port in a network fabric, a first packet of a flow (operation 402). For example, in FIG. 1, switch 120, acting as an ingress port in network fabric 110, may receive a first packet of a flow, as described above in relation to the flows of data traveling from IP/Ethernet network 134 (as the source) to HPC network 132 (as the destination). As another example, ingress network device 220 in FIG. 2 may receive a plurality of flows (e.g., as indicated by communications 260.0 and 270.0).

The system determines a number of bytes remaining in the flow to be transmitted (operation 404). As described above in relation to FIGS. 3A and 3B, an ingress network device may obtain the BR directly (e.g., from a first packet of a message in the flow, a header, an extension header, an options field, a transport layer, a software- or hardware-related component, or a NIC). For example, ingress network device 220 in FIG. 2 may obtain the BR directly from, e.g., a first packet of a message indicated by communication 260.0. An ingress network device may also obtain the BR indirectly (e.g., by inference from historical analysis of flows or by network management software which learns the behavior associated with similar traffic or flows). For example, ingress network device 120 in FIG. 1 may obtain the BR indirectly based on historical analysis of flows, including by inferring a number or range of number of bytes remaining in previously recorded flows that may be similar to the received flow. Ingress network device 120 may also obtain the BR indirectly by using a tool which learns and analyzes the historical data associated with previously recorded similar flows, and the tool may provide the BR to ingress network device 120 based on the analysis. The tool may be, e.g., a machine learning model, any system based on artificial intelligence (AI), a product which provides results to queries based on analysis of historical data, etc.

The system stores, in a data structure, the number of bytes remaining in the flow to be transmitted (operation 406). For example, the ingress port may store the BR in a per-port data structure.

The system updates the number of bytes remaining in the flow in response to receiving from a source of the flow additional messages of the flow and from a destination of the flow acknowledgments (ACKs) corresponding to previously transmitted packets of the flow. If the system receives, from a source of the flow, additional messages of the flow (decision 408), the system updates the number of bytes remaining in the flow to be transmitted by incrementing, in the data structure, the number of bytes remaining to be transmitted (operation 410). For example, if ingress network device 220 receives another message corresponding to the flow of data (e.g., via communication 260.0), ingress network device 220 may increment the stored BR based on the number of bytes remaining as obtained directly from the additional message or indirectly from other sources or by other means.

If the system does not receive from the source of the flow additional messages of the flow (decision 408), and if the system receives from a destination of the flow ACKs corresponding to previously transmitted packets of the flow (decision 412), the system updates the number of bytes remaining in the flow to be transmitted by decrementing, in the data structure, the number of bytes remaining to be transmitted (operation 412). For example, if ingress network device 220 receives an ACK (not shown) corresponding to the previously transmitted packets of the flow, ingress network device 220 may decrement the stored BR based on the number of bytes remaining calculated based on receiving the corresponding ACK. Decisions 408 and 412 along with corresponding operations 410 and 414, respectively, may occur in the order depicted, in parallel, in a different order, or independent of each other. The operation continues at Label A of FIG. 4B.

FIG. 4B presents a flowchart 420 illustrating a method which facilitates selecting flows to reroute based on bytes remaining as an indicator, in accordance with an aspect of the present application. The system identifies, based on mid-fabric congestion detected by intermediate ports in the network fabric, a plurality of candidate flows to be rerouted (operation 422). For example, ingress network device 120 may identify candidate flows based on redirect ACKs received from intermediate switches 116 and 118, as described above in relation to FIG. 1. Ingress network device 120 may also identify candidate flows based on information tracked, maintained, obtained, or calculated by ingress network device 120.

The system selects a first flow from the candidate flows based on a respective number of bytes remaining in the flow, the first flow associated with a first path (operation 424). An ingress network device (such as ingress network device 220 in FIG. 2) may select the first flow based on a comparison of the number of bytes remaining in the flow to a bandwidth delay product (BDP), as described above in relation to FIGS. 1 and 2. An ingress network device (such as 120 in FIG. 1) may also select the first flow based on a quantization of values, e.g., two or more categories representing different ranges of the number of bytes remaining in the flow, where a respective category corresponds to a priority level assigned to flows associated with a respective range of the number of bytes remaining in the flow. As an example, ingress network device 120 in FIG. 1 may select the first flow to rerouted in the following manner: If the BR is less than a first predetermined threshold (e.g., the BDP itself or the BDP less another number), ingress network device 120 may choose to mark or assign a lower priority to a respective candidate flow, since rerouting such a flow (with a low BR) may not result in a significant improvement in performance and cost (i.e., a lesser impact); and if the BR is greater than a second predetermined threshold (e.g., the BDP itself or the BDP summed with another number), ingress network device 120 may choose to mark or assign a higher priority to a respective candidate flow, since rerouting such a flow (with a high BR) may result in a significant improvement in performance and cost (i.e., a greater impact).

In addition, an ingress network device (e.g., 120 or 220 in FIGS. 1 and 2, respectively) may select the first flow to be rerouted from the candidate flows based on a combination of the BR and other information available to the ingress network device. An ingress network device may also apply a pseudo-random selection to flows marked as a good candidate (e.g., assigned with a higher priority) for rerouting and may further assign a higher probability of being rerouted to those flows.

The system reroutes the first flow from the first path to a new path (operation 426), as described above in relation to the flow of data from ingress network device 220 related to “first path” 260 as the first path and the flow of data from ingress network device 220 related to “new path” 270.

Thus, by using the number of bytes remaining in a flow to be transmitted (BR) as an indicator of when to reroute flows in a network fabric, the described aspects provide a mechanism by which an ingress network device can perform an optimal selection of which candidate flows to reroute, which can result in a significant improvement in performance and a more efficient overall system.

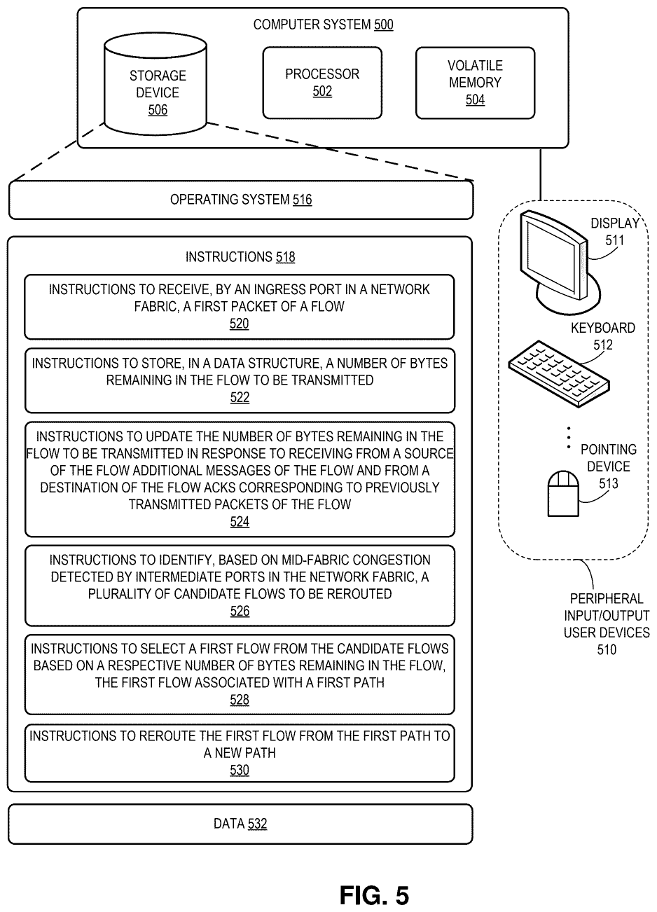

FIG. 5 illustrates a computer system 500 which facilitates selecting flows to reroute based on bytes remaining as an indicator, in accordance with an aspect of the present application. Computer system 500 includes a processor 502, a memory 504, and a storage device 506. Memory 504 may include a volatile memory (e.g., random access memory (RAM)) that serves as a managed memory and can be used to store one or more memory pools. Furthermore, computer system 500 may be coupled to peripheral I/O user devices 510 (e.g., a display device 511, a keyboard 512, and a pointing device 513). Storage device 506 includes non-transitory computer-readable storage medium and stores an operating system 516, instructions 518, and data 532. Computer system 500 may include fewer or more entities or instructions than those shown in FIG. 5.

Instructions 518, when executed by computer system 500, can cause computer system 500 to perform methods and/or processes described in this disclosure, e.g., including computer system 500 operating as an ingress network device. Specifically, instructions 518 may include instructions 520 to receive, by an ingress port, a first packet of a flow, as described above in relation to ingress network devices 120 and 220 of, respectively, FIGS. 1 and 2, and operation 402 of FIG. 4A.

Instructions 518 may include instructions 522 to store, in a data structure, a number of bytes remaining in the flow to be transmitted. Determining the number of bytes remaining in the flow to be transmitted is described above in relation to operation 404 of FIG. 4A, while storing the determined number of bytes is described above in relation to operation 406 of FIG. 4A.

Instructions 518 may include instructions 524 to update the number of bytes remaining in the flow in response to receiving from a source of the flow additional messages of the flow and from a destination of the flow ACKs corresponding to previously transmitted packets of the flow, as described above in relation to decision 408, operation 410, decision 412, and operation 414 of FIG. 4A as well as in relation to the operations of ingress network devices 120 and 220 of, respectively, FIGS. 1 and 2.

Instructions 518 may include instructions 526 to identify, based on mid-fabric congestion detected by the intermediate ports, a plurality of candidate flows to be rerouted, as described above in relation to operation 422 of FIG. 4B.

Instructions 518 may include instructions 528 to select a first flow from the candidate flows based on a respective number of bytes remaining in the flow, the first flow associated with a first path, as described above in relation to operation 424 of FIG. 4B.

Instructions 518 may include instructions 530 to reroute the first flow to a new path, as described above in relation to operation 426 of FIG. 4B.

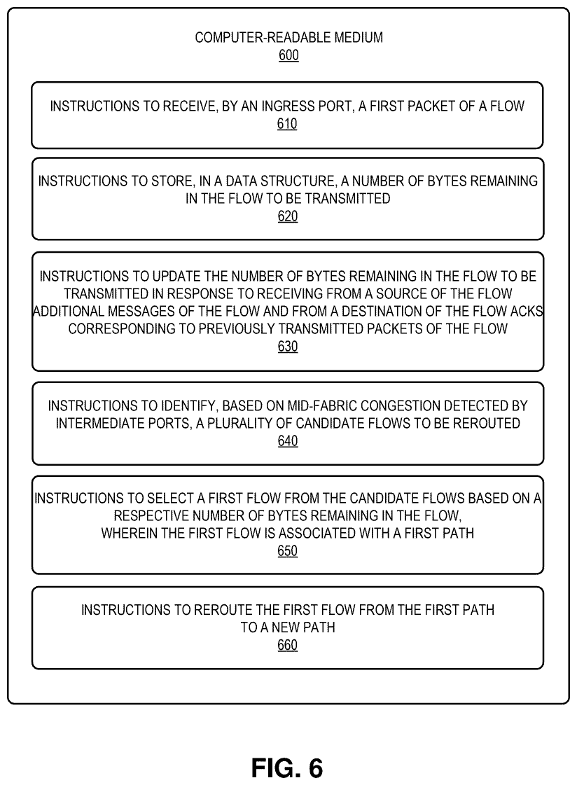

Instructions 518 may include more instructions than those shown in FIG. 5. For example, instructions 518 may include instructions for executing the operations described above in relation to: the environments of FIGS. 1 and 2; the operations depicted in the flowcharts of FIGS. 4A-4B; and the instructions of CRM 600 in FIG. 6.

Data 532 can include any data that is required as input or that is generated as output by the methods, operations, communications, and/or processes described in this disclosure. Specifically, data 532 can store at least: a flow; data of a flow; information associated with a flow or a packet of a flow; a load metric; a number of bytes remaining in a flow to be transmitted; additional messages or packets of a previously received flow; ACKs corresponding to previously transmitted packets of a flow; an indicator of mid-fabric congestion; a load metric or other information associated with a port or link; a BDP; a result of a comparison of the BR to the BDP; one or more predetermined or preconfigured thresholds; a category; a score or rank or order; an assigned weight or priority; a redirect ACK; a redirect ACK corresponding to a flow and including a load metric; a plurality of candidate flows; a selected flow of a plurality of candidate flow; a first path; an original path; a same path; a new path; a path for rerouting a flow; a data structure; an entry in a data structure; a probability of selecting a flow to be rerouted; a factor; a header; an extension header; an option; an indicator of a transport layer, a software- or hardware-related component, or a NIC; a size of a packet; a product of the load and the packet size; a bandwidth consumption; an amount of data pending in an output or input buffer; and information received from a NIC or associated with a state of a flow.

FIG. 6 illustrates a computer-readable medium (CRM) 600 which facilitates selecting flows to reroute based on bytes remaining as an indicator, in accordance with an aspect of the present application. CRM 600 can be a non-transitory computer-readable medium or device storing instructions that when executed by a computer or processor cause the computer or processor to perform a method. CRM 600 may store instructions 610 to receive, by an ingress port, a first packet of a flow, as described above in relation to ingress network devices 120 and 220 of, respectively, FIGS. 1 and 2, and operation 402 of FIG. 4A.

CRM 600 may store instructions 620 to store, in a data structure, a number of bytes remaining in the flow to be transmitted. Determining the number of bytes remaining in the flow to be transmitted is described above in relation to operation 404 of FIG. 4A, while storing the determined number of bytes is described above in relation to operation 406 of FIG. 4A.

CRM 600 may store instructions 630 to update the number of bytes remaining in the flow in response to receiving from a source of the flow additional messages of the flow and from a destination of the flow ACKs corresponding to previously transmitted packets of the flow, as described above in relation to decision 408, operation 410, decision 412, and operation 414 of FIG. 4A as well as in relation to the operations of ingress network devices 120 and 220 of, respectively, FIGS. 1 and 2.

CRM 600 may store instructions 640 to identify, based on mid-fabric congestion detected by intermediate ports, a plurality of candidate flows to be rerouted, as described above in relation to operation 422 of FIG. 4B.

CRM 600 may store instructions 650 to select a first flow from the candidate flows based on a respective number of bytes remaining in the flow, wherein the first flow is associated with a first path, as described above in relation to operation 424 of FIG. 4B.

CRM 600 may store instructions 660 to reroute the first flow to a new path, as described above in relation to operation 426 of FIG. 4B.

CRM 600 may include more instructions than those shown in FIG. 6. For example, CRM 500 may also store instructions for executing the operations described above in relation to: the environments of FIGS. 1 and 2; the operations depicted in the flowcharts of FIGS. 4A-4B; and the instructions of computer system 500 in FIG. 5.

The term “network device” refers to any device, component, or computing entity which can provide a communication pipeline for packets sent from a “processing node” or an “endpoint node.” A processing or endpoint node can refer to a device, component, or hardware component which can operate as a source or a destination of data, including e.g., a control packet or a data packet. A network device may include an ingress network device, an intermediate or mid-fabric network device, or an egress or endpoint network device. An example of a network device may be a switch, as described above in relation to FIG. 1. A processing node or endpoint node can include an ingress node (which is an endpoint for data returned from a request) or an egress node (which is an endpoint for data sent from a request). Additionally, a network device may operate as or perform the functionality described herein of an ingress network device, an intermediate network device, or an egress network device. An ingress node may be connected to an ingress port of the network, and an egress node may be connected to an egress port of the network.

In general, the disclosed aspects provide a computing system, a method, and a computer-readable medium which facilitate selecting flows to reroute based on bytes remaining as an indicator. The system receives, by an ingress port in a network fabric, a first packet of a flow. The system stores, in a data structure, a number of bytes remaining in the flow to be transmitted. The system updates the number of bytes remaining in the flow in response to receiving from a source of the flow additional messages of the flow and from a destination of the flow acknowledgments (ACKs) corresponding to previously transmitted packets of the flow. The system identifies, based on mid-fabric congestion detected by intermediate ports in the network fabric, a plurality of candidate flows to be rerouted. The system selects a first flow from the candidate flows based on a respective number of bytes remaining in the flow, the first flow associated with a first path. The system reroutes the first flow from the first path to a new path.

In a variation on this aspect, the system determines the number of bytes remaining in the flow based on information obtained from at least one of: the first packet; a header; an extension header; an IP option; a transport layer header; a software- or hardware-related component; or a network interface controller (NIC).

In a further variation on this aspect, the system determines the number of bytes remaining in the flow based on information inferred from historical data associated with the flow.

In a further variation, the system updates the number of bytes remaining in the flow by: incrementing, in the data structure, the number of bytes remaining in response to receiving the additional messages of the flow; and decrementing, in the data structure, the number of bytes remaining in response to receiving the ACKs corresponding to the previously transmitted packets of the flow.

In a further variation, the system identifies the plurality of candidate flows to be rerouted further based on redirect ACKs received from the intermediate ports.

In a further variation, the system selects the first flow from the candidate flows further based on at least one of: a comparison of the number of bytes remaining in the flow to a bandwidth delay product, wherein the bandwidth delay product comprises a product of a bandwidth of the network and a round-trip time associated with a packet; or two or more categories representing different ranges of the number of bytes remaining in the flow, wherein a respective category corresponds to a priority level assigned to flows associated with a respective range of the number of bytes remaining in the flow.

In a further variation, the system selects the first flow from the candidate flows further based on a combination of the number of bytes remaining in the flow and information available to the ingress port.

In a further variation, the system selects the first flow from the candidate flows by: marking a respective flow as a poor candidate for rerouting in response to the number of bytes being less a first predetermined threshold; and marking a respective flow as a good candidate for rerouting in response to the number of bytes being greater than a second predetermined threshold.

In a further variation, the system applies a pseudo-random selection to flows marked as a good candidate for rerouting. The system assigns a higher probability of being rerouted to the flows marked as a good candidate for rerouting.

In another aspect, a computing system operates in a network fabric including ingress ports and intermediate ports. The computing system comprises a processing resource and a storage device storing instructions which when executed by the processing resource comprise instructions. The instructions are to receive, by an ingress port, a first packet of a flow. The instructions are further to store, in a data structure, a number of bytes remaining in the flow to be transmitted. The instructions are further to update the number of bytes remaining in the flow in response to receiving from a source of the flow additional messages of the flow and from a destination of the flow ACKs corresponding to previously transmitted packets of the flow. The instructions are further to identify, based on mid-fabric congestion detected by the intermediate ports, a plurality of candidate flows to be rerouted. The instructions are further to select a first flow from the candidate flows based on a respective number of bytes remaining in the flow, the first flow associated with a first path. The instructions are further to reroute the first flow to a new path. The computing system may also include additional instructions, including in relation to: the environments of FIGS. 1 and 2; the operations depicted in the flowcharts of FIGS. 4A-4B; and the instructions of CRM 600 in FIG. 6.

In another aspect, a non-transitory computer-readable storage medium (or CRM) stores instructions to receive, by an ingress port, a first packet of a flow. The instructions are further to store, in a data structure, a number of bytes remaining in the flow to be transmitted. The instructions are further to update the number of bytes remaining in the flow in response to receiving from a source of the flow additional messages of the flow and from a destination of the flow ACKs corresponding to previously transmitted packets of the flow. The instructions are further to identify, based on mid-fabric congestion detected by the intermediate ports, a plurality of candidate flows to be rerouted. The instructions are further to select a first flow from the candidate flows based on a respective number of bytes remaining in the flow, the first flow associated with a first path. The instructions are further to reroute the first flow to a new path. The CRM may also store instructions for executing the operations described above in relation to: the environments of FIGS. 1 and 2; the operations depicted in the flowcharts of FIGS. 4A-4B; and the instructions of computer system 500 in FIG. 5.

The foregoing description is presented to enable any person skilled in the art to make and use the aspects and examples, and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown, but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
receiving, by an ingress port in a network fabric, a first packet of a flow;
storing, in a data structure, a number of bytes remaining in the flow to be transmitted;
updating the number of bytes remaining in the flow in response to receiving from a source of the flow additional messages of the flow and from a destination of the flow acknowledgments (ACKs) corresponding to previously transmitted packets of the flow;
identifying, based on mid-fabric congestion detected by intermediate ports in the network fabric, a plurality of candidate flows to be rerouted;
selecting a first flow from the candidate flows based on a respective number of bytes remaining in the flow, the first flow associated with a first path; and
rerouting the first flow from the first path to a new path.

2. The method of claim 1, further comprising:
determining the number of bytes remaining in the flow based on information obtained from at least one of:
the first packet;
a header;
an extension header;
an Internet Protocol (IP) option;
a transport layer header;
a software- or hardware-related component; or
a network interface controller (NIC).

3. The method of claim 1, further comprising:
determining the number of bytes remaining in the flow based on information inferred from historical data associated with the flow.

4. The method of claim 1, wherein updating the number of bytes remaining in the flow comprises:
incrementing, in the data structure, the number of bytes remaining in response to receiving the additional messages of the flow; and
decrementing, in the data structure, the number of bytes remaining in response to receiving the ACKs corresponding to the previously transmitted packets of the flow.

5. The method of claim 1,
wherein identifying the plurality of candidate flows to be rerouted is further based on redirect ACKs received from the intermediate ports.

6. The method of claim 1, wherein selecting the first flow from the candidate flows is further based on at least one of:
a comparison of the number of bytes remaining in the flow to a bandwidth delay product,
wherein the bandwidth delay product comprises a product of a bandwidth of the network and a round-trip time associated with a packet; or
two or more categories representing different ranges of the number of bytes remaining in the flow,
wherein a respective category corresponds to a priority level assigned to flows associated with a respective range of the number of bytes remaining in the flow.

7. The method of claim 1, wherein selecting the first flow from the candidate flows is further based on:
a combination of the number of bytes remaining in the flow and information available to the ingress port.

8. The method of claim 1, wherein selecting the first flow from the candidate flows comprises:
marking a respective flow as a poor candidate for rerouting in response to the number of bytes being less a first predetermined threshold; and
marking a respective flow as a good candidate for rerouting in response to the number of bytes being greater than a second predetermined threshold.

9. The method of claim 8, further comprising:
applying a pseudo-random selection to flows marked as a good candidate for rerouting; and
assigning a higher probability of being rerouted to the flows marked as a good candidate for rerouting.

10. A computing system operating in a network fabric including ingress ports and intermediate ports, the computing system comprising:
a processing resource; and
a storage device storing instructions which when executed by the processing resource comprise instructions to:
receive, by an ingress port, a first packet of a flow;
store, in a data structure, a number of bytes remaining in the flow to be transmitted;
update the number of bytes remaining in the flow in response to receiving from a source of the flow additional messages of the flow and from a destination of the flow acknowledgments (ACKs) corresponding to previously transmitted packets of the flow;
identify, based on mid-fabric congestion detected by the intermediate ports, a plurality of candidate flows to be rerouted;
select a first flow from the candidate flows based on a respective number of bytes remaining in the flow, the first flow associated with a first path; and
reroute the first flow to a new path.

11. The computing system of claim 10, wherein the instructions are further to:
determine the number of bytes remaining in the flow based on information obtained from at least one of:
the first packet;
a header;
an extension header;
an Internet Protocol (IP) option;
a transport layer header;
a software- or hardware-related component; or
a network interface controller (NIC).

12. The computing system of claim 10, wherein the instructions are further to:
determine the number of bytes remaining in the flow based on information inferred from historical data associated with the flow.

13. The computing system of claim 10, wherein the instructions are further to:
update the number of bytes remaining in the flow by:
incrementing, in the data structure, the number of bytes remaining in response to receiving the additional messages of the flow; and
decrementing, in the data structure, the number of bytes remaining in response to receiving the ACKs corresponding to the previously transmitted packets of the flow.

14. The computing system of claim 10, wherein the instructions are further to:
select the first flow from the candidate flows further based on at least one of:
a comparison of the number of bytes remaining in the flow to a bandwidth delay product,
wherein the bandwidth delay product comprises a product of a bandwidth of the network and a round-trip time associated with a packet; or
two or more categories representing different ranges of the number of bytes remaining,
wherein a respective category corresponds to a priority level assigned to flows associated with a respective range of the number of bytes remaining in the flow.

15. The computing system of claim 10, wherein the instructions are further to:
select the first flow from the candidate flows further based on a combination of the number of bytes remaining in the flow and information available to the ingress port.

16. The computing system of claim 10, wherein the instructions are further to:
select the first flow from the candidate flows by:
marking a respective flow as a poor candidate for rerouting in response to the number of bytes being less a first predetermined threshold; and
marking a respective flow as a good candidate for rerouting in response to the number of bytes being greater than a second predetermined threshold.

17. The computing system of claim 16, wherein the instructions are further to:
apply a pseudo-random selection to flows marked as a good candidate for rerouting; and
assign a higher probability of being rerouted to the flows marked as a good candidate for rerouting.

18. A non-transitory computer-readable medium storing instructions which when executed by at least one processing resource comprise instructions to:
receive, by an ingress port, a first packet of a flow;
store, in a data structure, a number of bytes remaining in the flow to be transmitted;
update the number of bytes remaining in the flow in response to receiving from a source of the flow additional messages of the flow and from a destination of the flow acknowledgments (ACKs) corresponding to previously transmitted packets of the flow;
identify, based on mid-fabric congestion detected by intermediate ports, a plurality of candidate flows to be rerouted;
select a first flow from the candidate flows based on a respective number of bytes remaining in the flow, wherein the first flow is associated with a first path; and
reroute the first flow to a new path.

19. The non-transitory computer-readable medium of claim 18, wherein the instructions are further to:
determine the number of bytes remaining in the flow based on information obtained from at least one of:
the first packet;
a header;
an extension header;
an Internet Protocol (IP) option;
a transport layer header;
a software- or hardware-related component;
a network interface controller (NIC)I; or
information inferred from historical data associated with the flow.

20. The non-transitory computer-readable medium of claim 18, wherein the instructions are further to:
select the first flow from the candidate flows further based on at least one of:
a comparison of the number of bytes remaining in the flow to a bandwidth delay product,
wherein the bandwidth delay product comprises a product of a bandwidth of the network and a round-trip time associated with a packet; or
a comparison of the number of bytes remaining to an upper threshold and a lower threshold; or
two or more categories representing different ranges of the number of bytes remaining,
wherein a respective category corresponds to a priority level assigned to flows associated with a respective range of the number of bytes remaining in the flow.
